(19) United States
(12) Patent Application Publication
(10) Pub. No.: US 2008/0257117 A1
(43) Pub. Date: Oct. 23, 2008

(54) One-Way Ratchet Wrench

(76) Inventor: Chunwei Yang, Hangzhou (CN)

Correspondence Address: GLOBAL IP SERVICES, 7285 W. Eagle Court, Winton, CA, 95388, US

(21) Appl. No.: 12/040,900

(22) Filed: Mar. 2, 2008

(30) Foreign Application Priority Data
Apr. 23, 2007 (CN) ZL200720108388.2

(51) Int. Cl. B25B 13/46

(52) U.S. Cl. 81/60

(57) ABSTRACT

The present invention relates generally to wrench—a manual tool, and more particularly to an one-way ratchet wrench, comprising: a wrench body, a ratchet wheel, a ratchet teeth and a magnetic coupling piece. The magnetic coupling piece provided on other side of the recess groove opposite to the ratchet teeth and against the side wall of recess groove, a spring provided between the magnetic coupling piece and the ratchet teeth, with one end fixed magnetically to the magnetic coupling piece and other end connected and fixed to the ratchet teeth. The one-way ratchet wrench according to this invention features rational structure and easy manufacture and assembly.

### CROSS REFERENCE TO RELATED PATENT APPLICATION

This application claims the priority of the Chinese patent application No. ZL200720108388.2 with a filing date of Apr. 23, 2007, which application is incorporated herein by reference.

### FIELD OF THE INVENTION

The present invention relates generally to wrench—a manual tool, and more particularly to A one-way ratchet wrench.

### BACKGROUND OF THE INVENTION

The conventional one-way ratchet wrench is provided with a head at one end of wrench body, comprising an input groove formed in the head and a recess groove connected to the input groove. A ratchet wheel is provided inside input groove and fixed by a circular open-ended clip and a polygonal hole is formed in the center of ratchet wheel, usually hexagonal or dodecagonal. The ratchet wheel can rotate freely inside the input groove. A ratchet teeth is provided on one side of recess groove against the side wall of said recess groove. A teeth portion on the side of ratchet teeth can be engaged with the teeth portion of ratchet wheel in a detachable way. A coupling piece opposite to the ratchet teeth and against the side wall of recess groove is provided on one side of recess groove. Both opposite faces of the coupling piece and ratchet teeth have a milled through hole in which a spring is provided.

The one-way ratchet wrench using conventional art needs the holes milled in the coupling piece and ratchet teeth, thus lacking competitiveness in manufacture easiness and cost.

### SUMMARY OF THE INVENTION

An object of the present invention is to provide a one-way ratchet wrench of rational structure and easy manufacture and assembly.

The present invention solves the above-mentioned technical problem by the following technical solution: A one-way ratchet wrench comprising: A wrench body having a head on one end, an input groove formed in the head, a recess groove connected to the input groove, and a circular open-ended clip inserted in the inner circumference of the input groove; A ratchet wheel with a polygonal hole in the center mounted inside the input groove in rotatable, the circular open-ended clip stopping the ratchet wheel out of the input groove; A ratchet teeth having a teeth portion on one side being provided on one side of the recess groove against a side wall of the recess groove, the teeth portion of ratchet teeth engaging with teeth of the ratchet wheel in a detachable way; A magnetic coupling piece provided on other side of the recess groove opposite to the ratchet teeth and against the side wall of recess groove, a spring provided between the magnetic coupling piece and the ratchet teeth, with one end fixed magnetically to the magnetic coupling piece and other end connected and fixed to the ratchet teeth. Either magnetic or metal spring may be used.

Preferably, a bulge is formed at one end of the ratchet teeth and the spring mounted on the bulge is connected and fixed to the ratchet teeth.

Preferably, a magnetic bulge is formed at one end of the magnetic coupling piece and the spring mounted on the magnetic bulge is magnetically fixed to the magnetic coupling piece.

The embodiment according to the present technical solution has advantages as follows:
1. a one-way ratchet wrench provided by the present invention, because its magnetic coupling piece can be sucked tightly inside the recess groove while magnetic metal spring is used, can magnetically and firmly connect the coupling piece to the spring without the hole milled in the coupling piece, so that manufacture difficulty and cost are effectively reduced, production efficiency promoted, and assembly of ratchet wrench becomes easier.
2. a one-way ratchet wrench provided by the present invention is provided with a bulge that is formed at one end of ratchet teeth and fabricated integrally with the ratchet teeth, so that manufacture difficulty for the ratchet wrench is further reduced.
3. a magnetic bulge is provided at one end of magnetic coupling piece and the spring is mounted on the magnetic bulge to secure the coupling between the spring and the magnetic piece more stably.

### BRIEF DESCRIPTION OF THE DRAWINGS

FIG. 1 is a schematic view showing A one-way ratchet wrench according to the present invention.

FIG. 2 is a schematic view showing an enlarged structure of A in FIG. 1.

FIG. 3 is a sectional view taken along the line B-B of FIG. 2.

FIG. 4 is a schematic view showing the structures of input groove and recess groove of the present invention.

FIG. 5 is a schematic view showing the structure of embodiment 2 of the present invention.

### DETAILED DESCRIPTION OF THE INVENTION

Hereinafter, preferred embodiments of the present invention will be described in detail with reference to the attached drawings 1 to 4.

### Embodiment 1

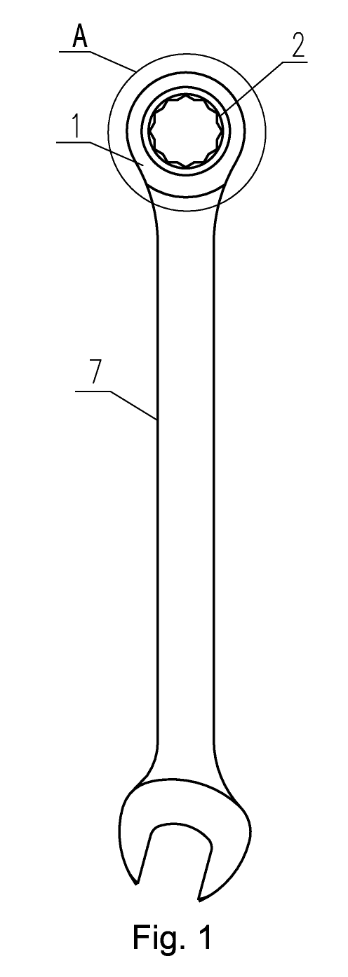

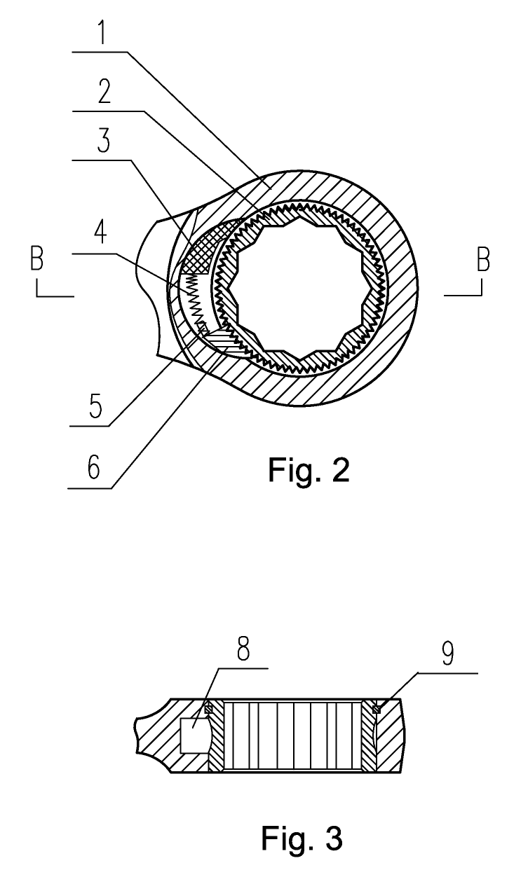

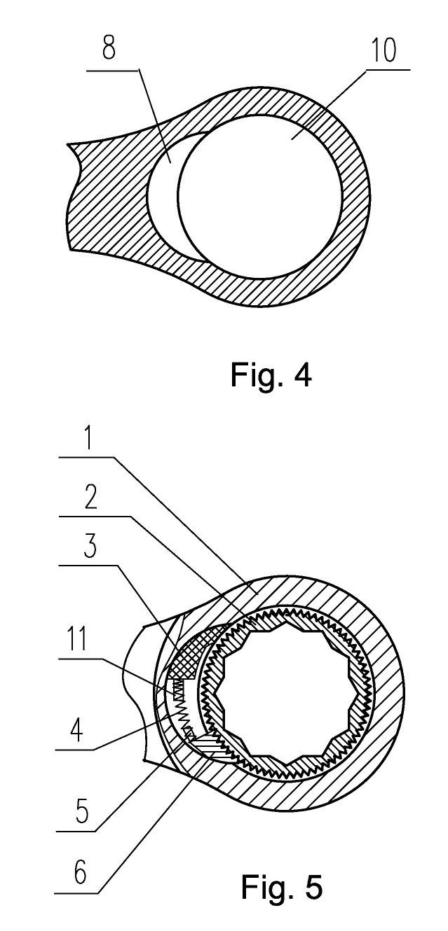

A one-way ratchet wrench as shown in FIG. 1 to 4, comprising:

A wrench body 7 having a head 1 on one end, an input groove 10 formed in the head, a recess groove 8 connected to the input groove 10, and a circular open-ended clip 9 inserted in the inner circumference of the input groove 10.

A ratchet wheel 2 with a dodecagonal hole in the center mounted inside the input groove 10 in rotatable, the circular open-ended clip 9 stopping the ratchet wheel 2 out of the input groove 10. The polygonal hole in the center of said ratchet wheel 2 can also be hexagonal.

A ratchet teeth 6 having a teeth portion on one side being provided on one side of the recess groove 8 against a side wall of the recess groove 8, the teeth portion of ratchet teeth 6 engaging with teeth of the ratchet wheel 2 in a detachable way.

A magnetic coupling piece 3 provided on other side of the recess groove 8 opposite to the ratchet teeth 6 and against the side wall of recess groove 8, a magnetic spring 4 provided between the magnetic coupling piece 3 and the ratchet teeth 6, with one end fixed magnetically to the magnetic coupling piece 3 and other end connected and fixed to the ratchet teeth 6.

A bulge 5 is formed at one end of the ratchet teeth 6 and the magnetic spring 4 mounted on the bulge 5 is connected and fixed to the ratchet teeth 6.

### Embodiment 2

A one-way ratchet wrench as shown in FIG. 5, comprising:

A wrench body 7 having a head 1 on one end, an input groove 10 formed in the head, a recess groove 8 connected to the input groove 10, and a circular open-ended clip 9 inserted in the inner circumference of the input groove 10.

A ratchet wheel 2 with a dodecagonal hole in the center mounted inside the input groove 10 in rotatable, the circular open-ended clip 9 stopping the ratchet wheel 2 out of the input groove 10. The polygonal hole in the center of said ratchet wheel 2 can also be hexagonal.

A ratchet teeth 6 having a teeth portion on one side being provided on one side of the recess groove 8 against a side wall of the recess groove 8, the teeth portion of ratchet teeth 6 engaging with teeth of the ratchet wheel 2 in a detachable way.

A magnetic coupling piece 3 provided on other side of the recess groove 8 opposite to the ratchet teeth 6 and against the side wall of recess groove 8, a iron spring 4 provided between the magnetic coupling piece 3 and the ratchet teeth 6, with one end fixed magnetically to the magnetic coupling piece 3 and other end connected and fixed to the ratchet teeth 6.

A magnetic bulge 11 is formed at one end of the magnetic coupling piece 3 and the iron spring 4 mounted on the magnetic bulge 11 is magnetically fixed to the magnetic coupling piece 3.

A bulge 5 is formed at one end of the ratchet teeth 6 and the iron spring 4 mounted on the bulge 5 is connected and fixed to the ratchet teeth 6.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A one-way ratchet wrench comprising:
a wrench body having a head on one end, an input groove formed in the head, a recess groove connected to the input groove and a circular open-ended clip inserted in the inner circumference of the input groove;
a ratchet wheel with a polygonal hole in the center mounted inside the input groove in rotatable, the circular open-ended clip stopping the ratchet wheel out of the input groove;
a ratchet teeth having a teeth portion on one side being provided on one side of the recess groove against a side wall of the recess groove, the teeth portion of ratchet teeth engaging with teeth of the ratchet wheel in a detachable way;
a magnetic coupling piece provided on other side of the recess groove opposite to the ratchet teeth and against the side wall of recess groove, a spring provided between the magnetic coupling piece and the ratchet teeth, with one end fixed magnetically to the magnetic coupling piece and other end connected and fixed to the ratchet teeth.

2. The one-way ratchet wrench according to claim 1, wherein a bulge is formed at one end of the ratchet teeth and the spring mounted on the bulge is connected and fixed to the ratchet teeth.

3. The one-way ratchet wrench according to claim 1, wherein a magnetic bulge is formed at one end of the magnetic coupling piece and the spring mounted on the magnetic bulge is magnetically fixed to the magnetic coupling piece.

4. The one-way ratchet wrench according to claim 2, wherein a magnetic bulge is formed at one end of the magnetic coupling piece and the spring mounted on the magnetic bulge is magnetically fixed to the magnetic coupling piece.
